(19) United States
(12) Patent Application Publication
(10) Pub. No.: US 2010/0112184 A1
(43) Pub. Date: May 6, 2010

(54) Coating solution, and manufacturing method and apparatus thereof

(75) Inventors: Takeshi Fukumori, Tokyo (JP); Shigeharu Kanemoto, Tokyo (JP); Keishi Wakabayashi, Tokyo (JP); Shuji Moritou, Tokyo (JP); Hiroyuki Maehara, Tokyo (JP)

Correspondence Address: STAAS & HALSEY LLP, SUITE 700, 1201 NEW YORK AVENUE, N.W., WASHINGTON, DC, 20005, US

(73) Assignee: SATAKE CORPORATION, Tokyo (JP)

(21) Appl. No.: 12/588,888

(22) Filed: Oct. 30, 2009

(30) Foreign Application Priority Data
Nov. 5, 2008 (JP) 2008-283866

(51) Int. Cl. A23L 1/308; A23L 1/10; A23P 1/08; A23L 1/0534; B01F 15/06

(52) U.S. Cl. 426/615; 426/506; 366/149

(57) ABSTRACT

There is provided a coating solution which can efficiently take in dietary fiber at high concentration. A manufacturing method and apparatus of the coating solution are provided. According to this method, the coating solution having high viscosity can be obtained. According to this apparatus, even if the added amount is larger compared to the amount of rice, a large amount of coated rice can be continuously manufactured without causing the clogging in the flow of rice and the coating solution in the apparatus and the binding of rice.

The coating solution is added at a ratio of 6.0 to 8.0% by weight to rice. The coating solution is made of a water solution of a mixture of one or more kinds of soluble dietary fiber and one or more kinds of insoluble dietary fiber. The mixture is at a ratio of one part by weight of the soluble dietary fiber and 0.5 to 2 parts by weight of the insoluble dietary fiber. The diluting ratio of the mixture and water is 7 parts by weight of the mixture and 3 parts by weight of the water.

### BACKGROUND OF THE INVENTION

1. Field of the Invention

The present invention relates to a coating solution which enables a large amount of dietary fiber to be coated onto the surface of rice, and a manufacturing method and apparatus thereof.

2. Description of the Related Art

To provide products excellent in nutrition and taste, conventionally, coated rice with various effective ingredients coated onto the surface thereof has been known. Japanese Patent Application Publication (JP-B) No. 06-026507 discloses a processed polished rice processing method wherein a water solution of one or more kinds of soluble dietary fiber selected from the group of decomposition substances such as guar gum, locust bean gum, tamarind gum, tara gum, pectin, and xanthan gum, and pullulan is sprayed onto the surface of polished rice subjected to a polishing process (a process for polishing unpolished rice) or a process for polishing polished rice (a process for polishing the surface of polished rice again) and is then dried. Japanese Patent Application Laid-Open (JP-A) No. 2003-169611 discloses a coated rice manufacturing method wherein at least any one of sugars such as starch syrup and a soluble polymer with cellulose as the main ingredient is added as the soluble dietary fiber at a ratio of 0.5 to 3% by weight to a raw material.

JP-B No. 06-026507 discloses an operation and effect in which when processed polished rice onto which the soluble dietary fiber is sprayed is boiled, the soluble dietary fiber is melted into water for rice boiling and enters into starch tissue at the completion of boiling to provide rice-specific viscosity, chewy properties, and gloss to the rice, thereby significantly improving taste. JP-A No. 2003-169611 discloses an operation and effect in which when at least any two of sugars such as starch syrup and a soluble polymer with cellulose as the main ingredient are used so that glossy coated rice excellent in appearance quality can be obtained.

In the coated rice manufacturing method disclosed in JP-B No. 06-026507 and JP-A No. 2003-169611, the viscosity of the coating solution (water solution) sprayed and added to rice is 100 cP (centipoises) or below. This is a viscosity equal to that of tomato juice and salad oil in a 24° C. environment. The coating solution is a non-viscous liquid coating solution. The coating solution needs be sprayed and dried plural times and stack coating layers so as to be uniformly coated onto rice. The coating solution of the related art has not been suitable for continuously manufacturing a large amount of coated rice.

### SUMMARY OF THE INVENTION

In view of the above problems, a technical object of the present invention is to provide a coating solution which can efficiently take in dietary fiber at high concentration, and a manufacturing method and apparatus of such coating solution. The manufacturing method and the apparatus can continuously manufacture a large amount of coated rice without causing the clogging in the flow of rice and the coating solution in the coated rice manufacturing apparatus and the binding of rice (the state that rice is bound together and becomes a lump due to the viscosity of the coating solution) even if the viscosity of the coating solution added to the surface of the rice is high and the added amount is large.

To address the above problems, the following means are adopted.

In an invention according to a first aspect, a coating solution which is added to rice to manufacture the coated rice, wherein the coating solution is made of a water solution of a mixture of one or more kinds of soluble dietary fiber and one or more kinds of insoluble dietary fiber, the mixture is at a ratio of one part by weight of the soluble dietary fiber and 0.5 to 2 parts by weight of the insoluble dietary fiber, and the diluting ratio of the mixture and water is 7 parts by weight of the mixture and 3 parts by weight of the water.

In an invention according to a second aspect, when the mixture and the water are diluted, hot water at a temperature of 40 to 80° C. is used for preparation.

In an invention according to a third aspect, when the mixture and the water are diluted, the viscosity is in the range of 320 to 1980 cP for preparation.

In an invention according to a fourth aspect, when the coating solution is prepared, the particle size of the insoluble dietary fiber is 10 to 20 μm.

In an invention according to a fifth aspect, a manufacturing method of the coating solution including the steps of: using a raw material made of a mixture of one or more kinds of soluble dietary fiber and one or more kinds of insoluble dietary fiber and hot water; mixing one part by weight of the soluble dietary fiber to 0.5 to 2 parts by weight of the insoluble dietary fiber; diluting the mixture in the step and hot water at 40 to 80° C. at a ratio of 7 parts by weight of the mixture and 3 parts by weight of the hot water; and thermally insulating and stirring the diluted mixture at a predetermined temperature so as to have a viscosity in the range of 320 to 1980 cP.

In an invention according to a sixth aspect, a manufacturing apparatus of the coating solution dilutes a mixture of one or more kinds of soluble dietary fiber and one or more kinds of insoluble dietary fiber by hot water to prepare the coating solution. The manufacturing apparatus has a preparing tank whose outside wall is covered by a thermal insulation jacket and including a stirrer therein, a supplying tank having the same configuration and the same volume as those of the preparing tank, a hot water reserving tank which circulates the hot water in the thermal insulation jacket, and steam supplying means which heats water in the hot water reserving tank. The preparing tank at the upper stage and the supplying tank at the lower stage are arranged in series so that the coating solution prepared by the preparing tank can be poured into the supplying tank and be reserved.

These inventions exhibit the following effects.

In the invention according to the first aspect, a coating solution which is coated onto the entire surface of rice is made of a water solution of a mixture of one or more kinds of soluble dietary fiber and one or more kinds of insoluble dietary fiber, and the mixing ratio of the mixture is one part by weight of the soluble dietary fiber and 0.5 to 2 parts by weight of the insoluble dietary fiber. The diluting ratio of the mixture to the water is 7 parts by weight of the mixture and 3 parts by weight of the water. The prepared coating solution has the same viscosity as that of a breaded pork cutlet sauce (a sauce poured on a fried pork cutlet of Japanese food) in a 24° C. environment, castor oil in a 20° C. environment, and honey or gum syrup in a 21° C. environment. The viscosity of the coating solution is higher than the related art. It is unnecessary to spray and dry the coating solution plural times to stack coating layers. The present invention is suitable for continuously manufacturing a large amount of coated rice. The viscosity of the coating solution is not excessively high. The clogging in the flow of rice and the coating solution in the coated rice manufacturing apparatus and the binding of rice can be lessened. The soluble dietary fiber and the insoluble dietary fiber can betaken in at high concentration at the same time. The effect for preventing a blood sugar level increase reducing action and constipation can be expected as a health supplement.

In the invention according to the second aspect, the coating solution is prepared by using hot water at 40 to 80° C. as a water temperature condition and being thermally insulated in this temperature range. The adjustment at a viscosity of 320 to 1480 cP is easy.

In the invention according to the third aspect, when the mixture of one or more kinds of soluble dietary fiber, one or more kinds of insoluble dietary fiber and water are diluted so that the viscosity would be in the range of 320 to 1480 cP for preparation, the viscosity of the coating solution can be easily close to that of a breaded pork cutlet in a 24° C. environment, castor oil in a 20° C. environment, and honey or gum syrup in a 21° C. environment.

In the invention according to the fourth aspect, when the coating solution is prepared, the insoluble dietary fiber having a particle size of 10 to 20 μm is used. The insoluble dietary fiber having a large particle size strongly tends to be precipitated onto the bottom portion of the tank in the mixing and diluting operations. The uniform mixing of the coating solution becomes difficult. Like the present invention, when the particle size is limited to 10 to 20 μm, the uniformly mixed coating solution can be prepared. The insoluble dietary fiber having a particle size limited to 10 to 20 μm is used so as to be coated onto polished rice. The particles of the insoluble dietary fiber are filled into the coated film. The number of the particles separated and desorbed from the coated film is decreased. The adherence yield to the polished rice can be drastically improved. In appearance, the surface of the finished coated rice is smoothened (or glossy without unevenness). The product value can be improved.

In the invention according to the fifth aspect, the coating solution having the same viscosity as that of a breaded pork cutlet in a 24° C. environment, castor oil in a 20° C. environment, and honey or gum syrup in a 21° C. environment can be manufactured. The soluble dietary fiber and the insoluble dietary fiber can be taken in at the same time. The coating solution which can prevent a blood sugar level increase reducing action and constipation can be manufactured as a health supplement.

In the invention according to a sixth aspect, the preparing tank and the supplying tank have the same configuration and the same volume. The coating solution in an amount used for an operation for half a day can be prepared by the respective tanks. The preparing tank at the upper stage and the supplying tank at the lower stage are arranged in series. The coating solution for half a day is prepared by the preparing tank, is poured into the supplying tank at the lower stage, and is reserved. The following coating solution for half a day is prepared by the preparing tank. The coating solution for one day can be prepared. When being insufficient, the coating solution can be additionally prepared. A large amount of coated rice can be continuously manufactured. The coating solution for half a day can be prepared. The present invention can easily cope with the change of each small lot due to the change of the type of rice and the change of the type of the coating solution (due to the different type of the soluble dietary fiber or the insoluble dietary fiber, the different mixing ratio in the water solution, and the different viscosity).

### BRIEF DESCRIPTION OF THE DRAWINGS

FIG. 1 is a flowchart showing the outline of a coated rice manufacturing apparatus of the present invention.

### DETAILED DESCRIPTION OF THE PREFERRED EMBODIMENTS

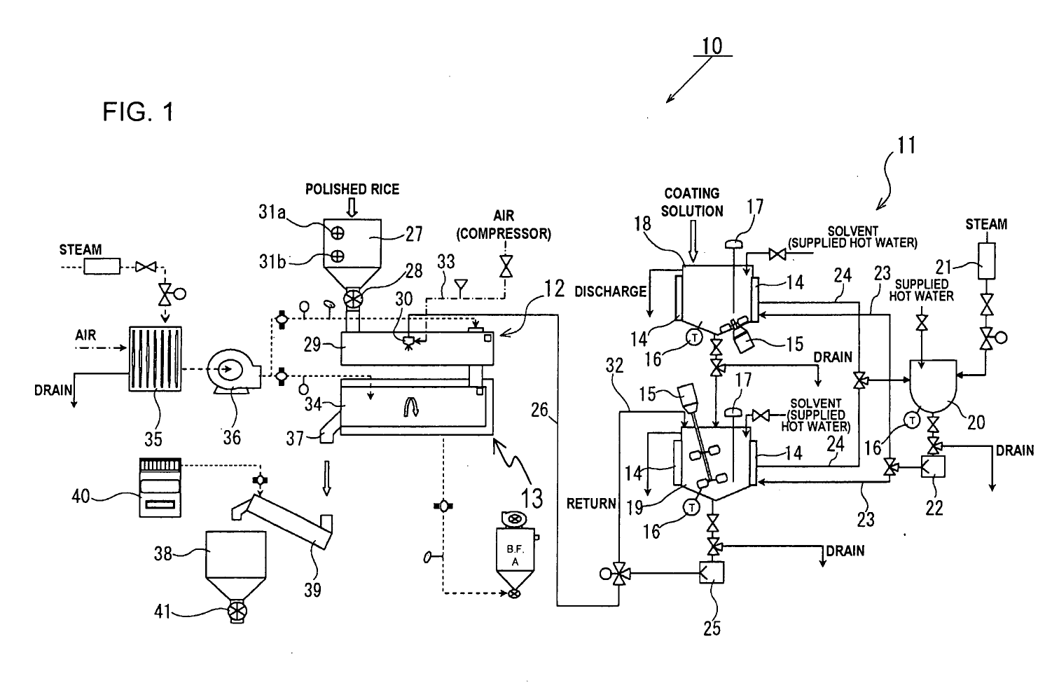

Best mode for embodying the present invention will be described with reference to the drawings. FIG. 1 is a flowchart showing the outline of a coated rice manufacturing apparatus of the present invention.

As shown in FIG. 1, a coated rice manufacturing apparatus 10 according to this embodiment mainly has a coating solution preparing portion 11, a coating process portion 12, and a drying process portion 13.

The coating solution preparing portion 11 dissolves, mixes, and stirs a mixture of one or more soluble dietary fiber and one or more insoluble dietary fiber in a solvent (hot water) adjusted to an appropriate temperature and prepares a coating solution (water solution) at a desired concentration and viscosity. The coating solution preparing portion 11 has a preparing tank 18 whose outside wall is covered by a thermal insulation jacket 14 and including a stirrer 15, a water temperature meter 16, and a water level gauge 17 therein, a supplying tank 19 having the same configuration as that of the preparing tank 18, a hot water reserving tank 20 which circulates hot water to the thermal insulation jacket 14, and steam supplying means 21 which heats water in the hot water reserving tank 20. Both the preparing tank 18 and the supplying tank 19 have a volume of 400 liters and, in this embodiment, can prepare the coating solution in an amount required for an operation for half a day. These are arranged in series. The coating solution for half a day is prepared by the preparing tank 18, is poured into the supplying tank 19 at the lower stage, and is reserved. The following coating solution for half a day is prepared by the preparing tank 18, whereby the coating solution for one day can be prepared. The two tanks are arranged in series. When the coating solution being insufficient, the coating solution can be additionally prepared. A large amount of coated rice can be continuously manufactured. The coating solution for half a day can be prepared. The present invention can easily cope with the change of each small lot due to the change of the type of rice and the change of the type of the coating solution.

The reference numeral 22 denotes a pump which circulates hot water from the hot water reserving tank 20 to the thermal insulation jacket 14. A hot water supplying pipe 23 is disposed in a path from the hot water reserving tank 20 to the thermal insulation jacket 14. A hot water returning pipe 24 is disposed in a path from the thermal insulation jacket 14 to the hot water reserving tank 20. The reference numeral 25 denotes a pump which supplies the coating solution from the supplying tank 19 to the coating solution process portion 12. A coating solution supplying pipe 26 is disposed from the supplying tank 19 to the adding and stirring portion of the coating solution process portion 12. A thermal insulating material may be wound on the coating solution supplying pipe 26 so that the liquid temperature of the coating solution passing therethrough is not lowered.

The coating process portion 12 has a raw material tank 27 which primarily reserves raw material rice, a rotary valve 28 which sets and controls the flow rate of the raw material rice, an adding and stirring portion 29 having a rotatable screw conveyor fitted in a laterally disposed cylinder, and a spraying device 30 disposed in the cylinder of the adding and stirring portion 29. Upper and lower level sensors 31a and 31b are provided in the raw material tank 27 and enable the operation control of operation start and end. The rotary valve 28, the adding and stirring portion 29, and the spraying device 30 are electrically communicated to a controller (not shown), thereby enabling the control preventing the clogging of rice in the cylinder, the control of the conveying speed of the adding and stirring portion 29 according to the flow rate set by the rotary valve 28, and the control of the added amount of the spraying device 30 according to the conveying speed of the adding and stirring portion 29.

The spraying device 30 is connected to the coating solution supplying pipe 26 communicated from the supplying tank 19. A coating solution circulation path 32 returning to the supplying tank 19 is branched from a path from the pump 25 to the coating solution supplying pipe 26. The spraying device 30 is connected to a pressurized air supplying pipe 33 which supplies pressurized air from an air compressor and enables the coating solution supplied to the spraying device 30 to be a mist as a gas-liquid mixed flow by the pressurized air from the pressured air supplying pipe 33. The coating solution will be described in detail later and is a water solution of a mixture of one or more kinds of soluble dietary fiber and one or more kinds of insoluble dietary fiber.

The drying process portion 13 has a drum body 34 which receives coating solution-added rice conveyed by the adding and stirring portion 29, into which hot air for drying is blown, and into which a rotor is fitted. A heater 35 which can adjust the temperature of a steam heat exchanger which blows hot air into the drum body 34 and a fan 36 which can adjust an air quantity are disposed around the drum body 34. As the rotor (not shown) fitted into the drum body 34, a ribbon screw having a screw vane having a shape so as to helically rotate a ribbon fitted to a rotational shaft, a stirring bar or a stirring paddle having a function of raking up the rice stayed on the bottom surface of the drum body 34, and a combination of these can be adopted. The number of revolutions of the stirring member is controlled according to the adding rate of the coating solution by the spraying device 30, the blow output of the fan 36, and the temperature setting of the heater 35. A takeout gutter 37 which discharges the coated rice to the outside is provided on the conveying terminal side of the drum body 34.

A blowing-up screw conveyer 39 which conveys the coated rice to a product tank 38 is inclined near the takeout gutter 37. An air conditioner 40 which enables temperature and moisture adjustment, such as a dehumidification cooler, which blows cooling air into the conveyor 39 is disposed around the blowing-up screw conveyer 39.

The product tank 38 temporarily reserves the coated rice. A shutter 41 which is automatically drivingly opens or closes the rotary valve is provided in a discharge portion at the lower end.

The operation of the manufacturing apparatus 10 will be described. Polished rice is fed to the raw material tank 27 by a feed charge lift. The polished rice which is temporarily reserved in the raw material tank 27 passes through the rotary valve 28 in the discharge portion at the lower end of the raw material tank, and is supplied to one end of the adding and stirring portion 29 configuring the coating process portion 12. The conveying speed, that is, the number of revolutions, of the screw conveyor of the adding and stirring portion 29 can be changeably set according to the flow rate set by the rotary valve 28.

The polished rice continuously supplied to the adding and stirring portion 29 at a predetermined flow rate is stirred and conveyed by the screw conveyer. The coating solution supplied from the supplying tank 19 by the pump 25 is mixed with pressurized air and is sprayed from the spraying device 30 to the polished rice being conveyed. The detailed ingredients and the mixing ratio of the coating solution will be described later. The coated rice discharged from the discharge portion of the adding and stirring portion 29 is received by the drum body 34 configuring the drying process portion 13. Hot air is blown into the drum body 34. Any excessive moisture of the coating solution coated onto the surface of the rice (polished rice) is removed for dry. The rotor fitted into the drum body 34 is rotated and moved for stirring. The coating solution uniformly adheres to the rice so that the surface of the rice can be smooth. In this embodiment, when the coated rice of 250 kg is manufactured per hour, the temperature of hot air is about 50° C. and the air quantity is about 10 m³/min, which can obtain a preferable result.

The coated and dried rice is taken out from the takeout gutter 37 of the drum body 34 to the outside and is fed to the product tank 38 via the blowing-up screw conveyer 39. Cool air is blown into the blowing-up screw conveyer 39. The rice is cooled while being conveyed. Any excessive rough heat causing color change and degradation of the rice (the amount of temperature rise roughly judged as being excessive) is removed. The coated rice is then fed to the product tank 38. In the present invention, the coating solution having a high viscosity of 100 cP or above (320 to 1480 cP) is used. The binding of rice is scarcely caused. It is unnecessary to provide a lump disintegrating device for loosening a lump of rice and a vibrating broom. Only the blowing-up screw conveyer 39 is provided and the installation of the disintegrating device can be omitted. The rice temporarily reserved in the product tank 38 is taken out by the driving of the shutter 41, if necessary, and is shipped.

Various kinds of coated rice and a specific manufacturing method using the manufacturing apparatus 10 will be described. The coating solution which is coated onto the entire surface of polished rice is made of a water solution of a mixture of one or more kinds of soluble dietary fiber and one or more kinds of insoluble dietary fiber. As the specific soluble dietary fiber, resistant dextrin or a hydrolysate manufactured from rice starch is suitable for actual use. As the specific insoluble dietary fiber, cellulose, pectin, insoluble hemicellulose, lignin, and resistant starch are suitable for actual use.

The mixing ratio of the soluble dietary fiber and the insoluble dietary fiber is preferably one part by weight of soluble dietary fiber and 0.5 to 2 parts by weight of the insoluble dietary fiber. A mixture of these and water (hot water) are stirred and mixed to prepare the coating solution. The diluting ratio of the mixture and water (hot water) is preferably 7 parts by weight of the mixture and 3 parts by weight of the water. As the temperature condition, preferably, the hot water at 40 to 80° C. is used and is thermally insulated in this temperature range for preparation. The viscosity of the prepared coating solution is about 320 to 1480 cP and is the same as that of a breaded pork cutlet in a 24° C. environment, castor oil in a 20° C. environment, and honey or gum syrup in a 21° C. environment. The viscosity of the coating solution is higher than the related art. The coating solution needs not be sprayed and dried plural times to stack coating layers. The coating solution of the present invention is suitable for continuously manufacturing a large amount of coated rice.

Although the particle size of the soluble dietary fiber needs not be limited due to solubility, the particle size of the insoluble dietary fiber needs be limited when the coating solution is prepared or is coated onto rice. When the insoluble dietary fiber having a large particle size is mixed for preparation, the insoluble dietary fiber having a large particle size strongly tends to be precipitated onto the bottom portion of the tank during the preparing operation. The uniform mixing of the coating solution becomes difficult. Although the mixture is strongly stirred so as to prepare the uniform coating solution, it is difficult to be emulsified. Like the coating solution of the present invention, the coating solution prepared using the insoluble dietary fiber having a particle size limited to 10 to 20 μm becomes in a uniformly mixed state.

When the coating solution is added to polished rice and is dried and the insoluble dietary fiber has a large particle size, the number of the particles separated and desorbed from the coated film formed on the surface of the polished rice is increased. The coating solution is coated onto the polished rice using the insoluble dietary fiber having a particle size limited to 10 to 20 μm. The particles are filled into the coated film. The number of the particles separated and desorbed from the coated film is decreased. The adherence yield to the polished rice can be drastically improved. In appearance, the surface of the finished coated rice is smoothened. The product value can be improved.

### Test Example 1

As an improvement of the related art, only the water solution of the soluble dietary fiber is diluted so as to be at a concentration of a 70 wt % to prepare the coating solution and it is examined whether or not the coating solution is appropriate as the coating solution for polished rice. As the soluble dietary fiber, the product name “NUTRIOSE (registered trademark)” (manufactured by Roquette in France and hereinafter, called “NUTRIOSE”) which is commercially available soluble resistant dextrin is used. Seven parts by weight of the NUTRIOSE and 3 parts by weight of the hot water at 50° C. are stirred and mixed to prepare the coating solution. The prepared coating solution is added at a ratio of 6.5% by weight to the polished rice to manufacture coated rice (Sample 1).

### Test Example 2

A mixture of one or more kinds of soluble dietary fiber and one or more kinds of insoluble dietary fiber is diluted by water to prepare the coating solution and it is examined whether or not the coating solution is appropriate as the coating solution for polished rice. As the soluble dietary fiber, the NUTRIOSE is used. As the insoluble dietary fiber, the product name “Fiber gym RW (registered trademark)” (manufactured by MGP Ingredients in the United States and hereinafter, called “Fiber gym”) which is resistant starch is used. The mixing ratio of the NUTRIOSE and the Fiber gym is one part of the NUTRIOSE and one part of the Fiber gym. The mixing ratio of a mixture of these and water (hot water) is 7 parts by weight of the mixture and 3 parts by weight of the water. As the temperature condition, hot water at 50° C. is used. The mixture is thermally insulated at this temperature for preparation. The prepared coating solution is added at a ratio of 6.5% by weight to the polished rice to manufacture the coated rice (Sample 2). The coating solution prepared in the same manner is used and is added at a ratio of 8.0% by weight to the polished rice to manufacture the coated rice (Sample 3).

The test results of Test examples 1 and 2 are shown in the following Table 1.

TABLE 1

| | | | Added | | | | |
|---|---|---|---|---|---|---|---|
| | Containing | Viscosity | amount | | | | |
| | of insoluble | of coating | to | Binding | | | |
| | dietary | solution | polished | of | Appearance | | Total |
| | fiber | (cP) | rice (%) | rice | of rice | Processability | evaluation |
| Sample 1 | No | 2000 | 6.8 | 2 | 5 | 1 | 1 |
| Sample 2 | Yes | 870 | 6.5 | 5 | 4 | 4 | 4 |
| Sample 3 | Yes | 870 | 8.0 | 4 | 4 | 3 | 3 |

(The items of binding, appearance, processability, and total evaluation are evaluated at five stages, respectively. As the number is larger, it is evaluated as being good.)

In Sample 1 of Table 1, the viscosity of the coating solution is about 2000 cP and is the same as that of condensed milk in a 21° C. environment. The rice adheres to the rotary valve and the vane of the screw conveyer in the coated rice manufacturing apparatus 10. It is thought that the coating solution in Sample 1 is not suitable as the coating solution for the polished rice.

In Samples 2 and 3 of Table 1, the viscosity of the coating solution is 870 cP and is in the range of 320 to 1480 cP. The coating solution has moderate viscosity and adhesiveness to the rice. The adhesiveness of the coating solution to the metal material in the coated rice manufacturing apparatus 10 is low. The motor load of the pumps 22 and 25 becomes smaller. It is found that the coating solution is optimum as the coating solution for the polished rice and is suitable for continuously manufacturing the coated rice.

As described above, according to this embodiment, the prepared coating solution has the same viscosity as that of a breaded pork cutlet sauce in a 24° C. environment, castor oil in a 20° C. environment, and honey or gum syrup in a 21° C. environment. The viscosity of the coating solution is higher than the related art. It is unnecessary to spray and dry the coating solution plural times to stack coating layers. The present invention is suitable for continuously manufacturing a large amount of coated rice. The viscosity of the coating solution is not excessively high. The clogging in the coated rice manufacturing apparatus and the binding of rice can be lessened. The soluble dietary fiber and the insoluble dietary fiber can be taken in at high concentration at the same time. The effect of a blood sugar level increase reducing action and constipation prophylaxis can be expected as a health supplement.

1. A coating solution which is added to rice to manufacture coated rice, wherein the coating solution is made of a water solution of a mixture of one or more kinds of soluble dietary fiber and one or more kinds of insoluble dietary fiber, the mixture is at a ratio of one part by weight of the soluble dietary fiber and 0.5 to 2 parts by weight of the insoluble dietary fiber, and the diluting ratio of the mixture and water is 7 parts by weight of the mixture and 3 parts by weight of the water.

2. The coating solution according to claim 1, wherein when the mixture and the water are diluted, hot water at a temperature of 40 to 80° C. is used for preparation.

3. The coating solution according to claim 1, wherein when the mixture and the water are diluted, the viscosity is in the range of 320 to 1480 cP for preparation.

4. The coating solution according to claim 1, wherein when the coating solution is prepared, the particle size of the insoluble dietary fiber is 10 to 20 μm.

5. A coating solution manufacturing method comprising the steps of:
using a raw material made of a mixture of one or more kinds of soluble dietary fiber and one or more kinds of insoluble dietary fiber and hot water;
mixing one part by weight of the soluble dietary fiber and 0.5 to 2 parts by weight of the insoluble dietary fiber;
diluting the mixture and hot water at 40 to 80° C. at a ratio of 7 parts by weight of the mixture and 3 parts by weight of the hot water; and
thermally insulating and stirring the diluted mixture at a predetermined temperature so as to have a viscosity in the range of 320 to 1480 cP.

6. A coating solution manufacturing apparatus which dilutes a mixture of one or more kinds of soluble dietary fiber and one or more kinds of insoluble dietary fiber by hot water to prepare a coating solution, the manufacturing apparatus comprising:
a preparing tank whose outside wall is covered by a thermal insulation jacket and including a stirrer therein, a supplying tank having the same configuration and the same volume as those of the preparing tank, a hot water reserving tank which circulates the hot water in the thermal insulation jacket, and steam supplying means which heats water in the hot water reserving tank, the preparing tank at the upper stage and the supplying tank at the lower stage being arranged in series so that the coating solution prepared by the preparing tank can be poured into the supplying tank and be reserved.

7. The coating solution according to claim 2, wherein when the mixture and the water are diluted, the viscosity is in the range of 320 to 1480 cP for preparation.

8. The coating solution according to claim 2, wherein when the coating solution is prepared, the particle size of the insoluble dietary fiber is 10 to 20 μm.

9. The coating solution according to claim 3, wherein when the coating solution is prepared, the particle size of the insoluble dietary fiber is 10 to 20 μm.

10. The coating solution according to claim 7, wherein when the coating solution is prepared, the particle size of the insoluble dietary fiber is 10 to 20 μm.
